(19) United States
(12) Patent Application Publication
(10) Pub. No.: US 2010/0174758 A1
(43) Pub. Date: Jul. 8, 2010

(54) AUTOMATIC MANAGEMENT OF SINGLE SIGN ON PASSWORDS

(75) Inventors: Zoran Radenkovic, Robina (AU); Peter T. Waltenberg, Robina (AU)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Amonk, NY (US)

(21) Appl. No.: 12/348,383

(22) Filed: Jan. 5, 2009

(51) Int. Cl. G06F 17/30; G06F 7/00

(52) U.S. Cl. 707/803; 726/6; 707/E17.005

(57) ABSTRACT

Identity Management (IdM) systems prevent a user from having to memorize numerous passwords for different resources, while Single Sign-On (SSO) systems allow a user to login to several resources by providing login credentials once. Since IdM systems propagate the same password to numerous resources, a compromised password for one resource would allow unauthorized access to all resources. A system can automatically generate unique passwords for each of a plurality of resources and update login information on each resource to reflect the unique password.

### BACKGROUND

Embodiments of the inventive subject matter generally relate to the field of network security, and, more particularly, to automatic management of single sign-on passwords.

Identity Management (IdM) systems manage account information of a plurality of users across a number of different resources (e.g., operating system, email, etc.). An IdM system stores identity information for the plurality of users and maintains login information of the users in a database and on the resources. Users do not have to remember many different passwords because an IdM system allows a user to access all of his or her resource accounts with the same password. Single Sign-On (SSO) adds another level of convenience when integrated with IdM because it allows the user to login to multiple resources without entering his or her password multiple times. The user supplies login credentials once, for example, when signing on an operating system. Then, in a background process, SSO logs the user into resources as the user requests access to those resources.

### SUMMARY

Embodiments include a method directed to determining that one or more current passwords for one or more resources in a single sign-on database should be changed. New passwords are generated for the one or more resources. Each of the one or more resources is automatically logged into with respective credentials. Login information on each of the one or more resources is updated with respective ones of the generated new passwords.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of generating unique passwords for a plurality of resources and updating login information on each resource.

FIG. 2 is a flowchart depicting example operations for generating new unique passwords for a plurality of resources and updating login information for each resource.

FIG. 3 is a flowchart depicting example operations for generating a new resource password and updating login information for the resource in response to detecting that a current password has expired.

FIG. 4 is a flowchart depicting example operations for detecting that SSO service is unavailable for a resource and displaying a password.

FIG. 5 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to Identity Management applications, embodiments may be implemented in other types of password management applications. In other instances, well-known instruction instances, protocols, structures and techniques have not been shown in detail in order not to obfuscate the description.

Identity Management (IdM) systems prevent a user from having to memorize numerous passwords for different resources, while Single Sign-On (SSO) systems allow a user to login to several resources by providing login credentials once. Since IdM systems propagate the same password to numerous resources, a compromised password for one resource would allow unauthorized access to all resources. A system can automatically generate unique passwords for each of a plurality of resources and update login information on each resource to reflect the unique password. Automatically creating unique passwords and updating login information for each resource improves security for each resource account while maintaining resource login convenience.

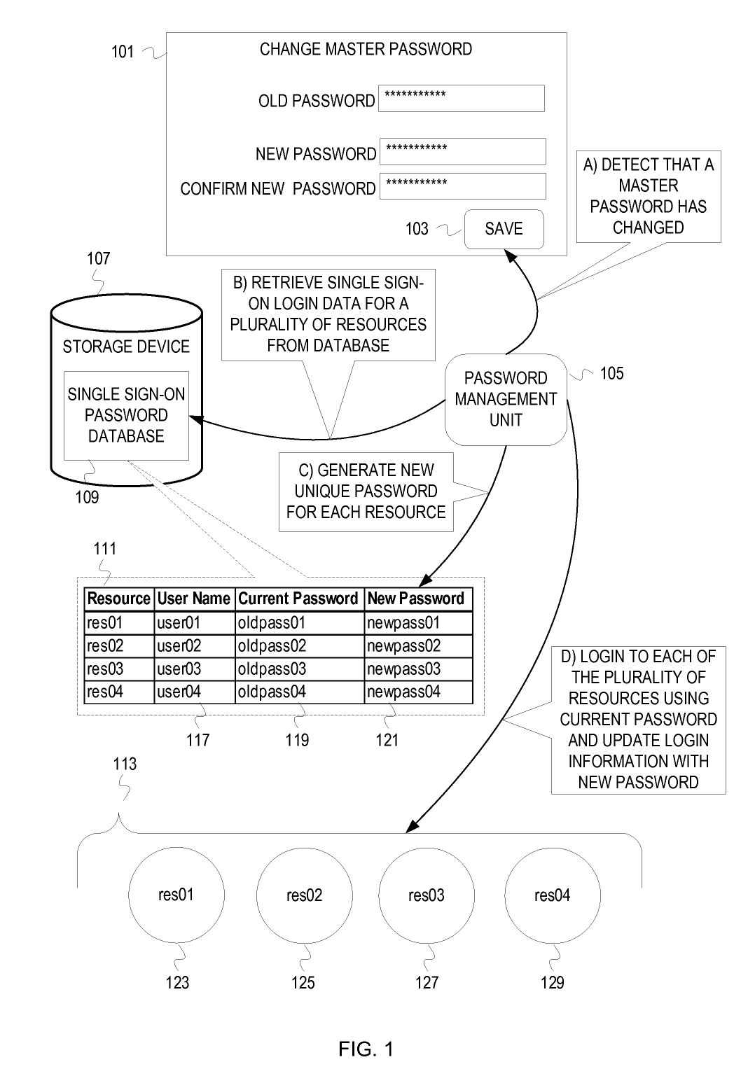

FIG. 1 depicts an example conceptual diagram of generating unique passwords for a plurality of resources and updating login information on each resource. At stage A, a password management unit 105 detects that a master password for a SSO environment has changed. In this example, a change master password dialog box 101 has been invoked by a user. The password management unit 105 detects that the password has changed when the user clicks a save button 103. Other examples of detecting that a master password has changed include detecting that a new master password has been typed, detecting selection of an update password option, etc.

At stage B, the password management unit 105, retrieves SSO login data 111 for a plurality of resources 113 from a database 109. A storage device 107 hosts the database 109. The storage device 107 may be located on a user's computer, a remote server, network attached storage, etc. Examples of resources include operating systems, e-mail accounts, company intranets, etc. In this example, the SSO login data 111 comprises resource names, user names, current passwords and new passwords for each resource in the plurality of resources 113. The plurality of resources 113 comprises four resources 123, 125, 127, and 129. The user names for each resource may or may not be the same. SSO login data 111 may contain other information such as last login, password expiration date, etc.

At stage C, the password management unit 105 generates a new unique password for each resource in the plurality of resources 113. The password management unit 105 stores the new passwords generated for each of the plurality of resources 113 in the database 109. The password management unit 105 may or may not generate the passwords based on the master password. The password management unit 105 can use a variety of techniques to generate a unique password based on the master password. Examples techniques include appending a random number to the master password, appending a token to the master password, etc. Example techniques for generating a unique password that is not based on the master password can include producing a random pattern of numbers and/or letters, incrementing a numeric part of an old password with a random number, etc. The password management unit 105 generates passwords for resources according to password policies established for each resource. For example, a password policy for an accounting application states that a password should contain at least 8 characters including one upper-case letter and one numeric character.

At stage D, the password management unit 105 logs in to each of the plurality of resources 113 using a current password and updates login information with the new password. In this example, the password management unit 105 updates passwords for the four resources 123, 125, 127 and 129. To update login information for the resource 129, the password management unit 105 logs in to the resource 129 using a username 117 and a current password 119 corresponding to resource 129. The password management unit 105 then updates login information of the resource 129 with a new password 121. Updating login information of a resource comprises changing a password stored in a database of the resource. Depending on the type of resource, the database may be on a user's computer, a remote server, etc. For example, login information for a financial web page is stored in a database on a web server. As another example, an operating system password is stored on a user's computer. Once the login information has been updated for resource 109, the password management unit 105 overwrites the current password 119 with the new password 121 in the SSO login data 111. The password management unit then stores the updated SSO login data 111 in the database 109.

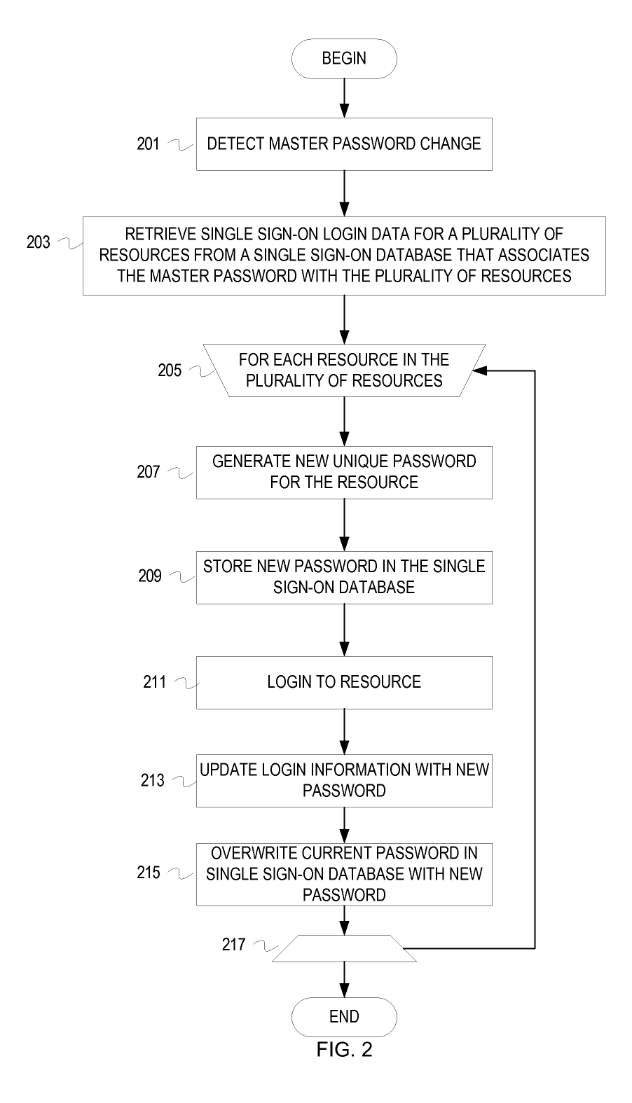

FIG. 2 is a flowchart depicting example operations for generating new unique passwords for a plurality of resources and updating login information for each resource. Flow begins at block 201, where a master password change is detected. For example, the master password expired and a user is prompted to enter a new password. The master password change can be detected when the user clicks a save new password button.

At block 203, SSO login data is retrieved for a plurality of resources from a single sign-on database that associates the master password with the plurality of resources. For example, single sign-on login data is retrieved from an employee database on a company's server.

At block 205, a loop begins for each resource in the plurality of resources.

At block 207, a new unique password is generated for the resource. For example, the new password is generated based on a series of five random letters followed by 5 random numbers.

At block 209, the new password is stored in the SSO database for the resource.

At block 211, the resource is logged into. A password management unit may login to the resource using its own user credentials. For example, the password management unit logs into the resource with an administrator user name and password. The password management unit then has access to all user account information stored at the resource. The password management unit may login to the resource with current credentials of a user. For example, the password management unit logs into the resource with a user name and current password corresponding to the user's account on the resource. The password management unit has access to the user's account information stored on the resource.

At block 213, login information for the user name on the resource is updated with the new password.

At block 215, the current password is overwritten with the new password in the SSO database.

At block 217, the loop ends.

Although examples refer to generating new passwords for a plurality of resources when a master password is changed, embodiments are not so limited. A security policy may specify that passwords for all resources in a single sign-on database should be changed after a certain amount of time regardless of whether or not a master password is changed. For example, the security policy specifies that passwords should be changed every three months.

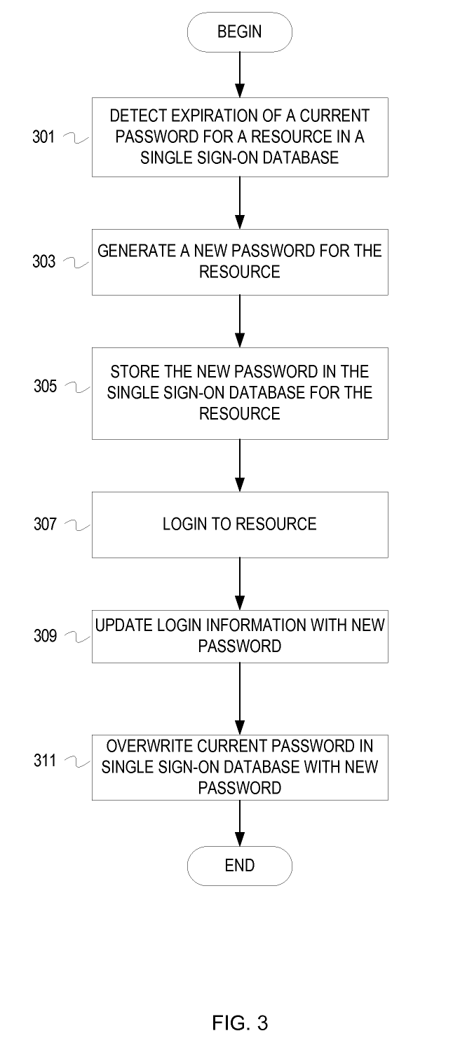

In addition to generating new passwords for a plurality of resources, new passwords may be generated for a resource when a current password expires, a user requests a password to be changed for the resource, etc. FIG. 3 is a flowchart depicting example operations for generating a new resource password and updating login information for the resource in response to detecting that a current password has expired. Flow begins at block 301, where expiration of a resource password is detected in a SSO database. Examples of detecting expiration of a resource password comprise detecting that the current date matches or is past the expiration date, detecting a notification that the password has expired when logging into a resource, etc.

At block 303, a new password is generated for the resource. In this case, the password is generated for a single resource, not every resource in the SSO database.

At block 305, the new password is stored in the SSO database for the resource.

At block 307, the resource is logged into.

At block 309, login information for the user name for the resource is updated with the new password.

At block 311, the current password in the SSO database is overwritten with the new password.

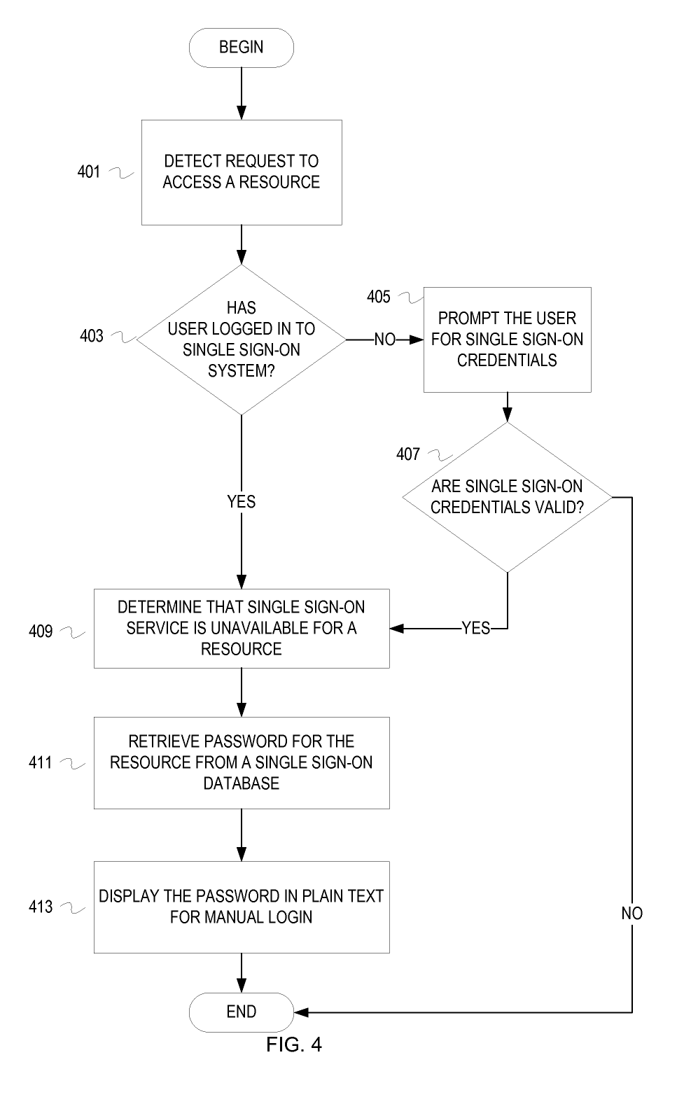

From time-to-time, SSO service may be unavailable for a resource. When SSO service is unavailable, a user cannot be automatically logged in to the resource. FIG. 4 is a flowchart depicting example operations for detecting that SSO service is unavailable for a resource and displaying a password. Flow begins at block 401, where a request to access a resource is detected. Examples of requests to access a resource include launching an application, opening a web page, accessing a server, etc.

At block 403, it is determined if a user has logged in to a SSO system. The user logs into the SSO system by providing credentials (e.g., a user name and a password). If the user has not logged in to the SSO system, flow continues at block 405. If the user has logged in to the SSO system, flow continues at block 409.

At block 405, the user is prompted for SSO credentials.

At block 407, it is determined if the SSO credentials are valid. If the SSO credentials are valid, flow continues at block 409. If the SSO credentials are not valid, flow ends.

At block 409, it is determined that SSO service is unavailable for a resource. Examples of determining that SSO service is unavailable for a resource include detecting an SSO login failure, detecting a communication error with a resource's SSO service, etc.

At block 411, a password for the resource is retrieved from a single sign on database. In some cases, a user name may also be retrieved.

At block 413, the password is displayed in plain text for manual login to the resource by a user. If a user name was retrieved, the user name will also be displayed.

It should be understood that the depicted flowchart are examples meant to aid in understanding embodiments and should not be used to limit embodiments or limit scope of the claims. Embodiments may perform additional operations, fewer operations, operations in a different order, operations in parallel, and some operations differently. For instance, referring to FIG. 2, operations for updating login information with the new password and overwriting the current password may occur in parallel.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

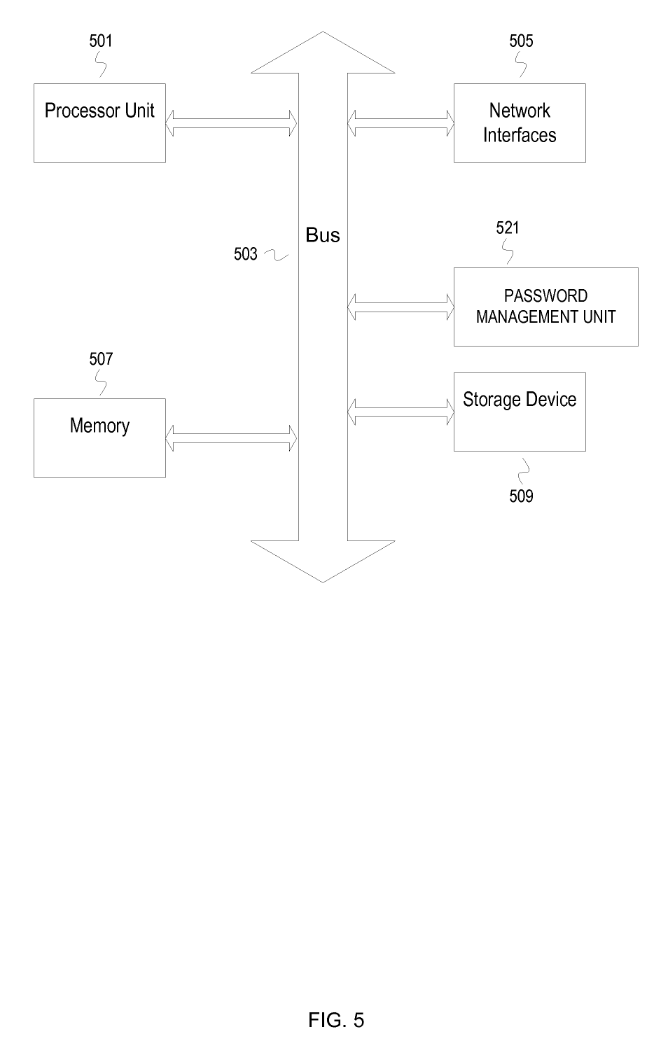

FIG. 5 depicts an example computer system. A computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The computer system also includes a password management unit 521 that generates unique SSO passwords for a plurality of resources and updates login information on each resource with the generated passwords. Any one of the functionalities for password management may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

While the embodiments are described with reference to various implementations and exploitations, it will be understood that these embodiments are illustrative and that the scope of the inventive subject matter is not limited to them. In general, techniques for managing SSO passwords as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining that one or more current passwords for one or more resources in a single sign-on database should be changed;
generating new passwords for the one or more resources;
automatically logging into each of the one or more resources with respective credentials; and
updating login information on each of the one or more resources with respective ones of the generated new passwords.

2. The method of claim 1, wherein determining that the one or more current single sign-on passwords for the one or more resources should be changed comprises at least one of detecting that a master password for a single sign-on environment has changed and detecting that a single sign-on password for a resource in the single-sign on database has expired.

3. The method of claim 1, wherein said generating the new passwords for the one or more resources comprises generating a first of the new passwords for a first of the one or more resources is based, at least in part, on a master password.

4. The method of claim 1, wherein said generating the new passwords for the one or more resources comprises generating a first of the new passwords for a first of the one or more resources independent of a master password.

5. The method of claim 1, wherein said credentials comprise one of administrator credentials and user credentials.

6. The method of claim 5 further comprising retrieving first credentials for a first of the one or more resources.

7. The method of claim 1 further comprising overwriting the current single sign-on password with the new single sign-on password for each of the one or more resources in the single sign-on database.

8. The method of claim 1 further comprising:
detecting that a single sign-on service is unavailable for a first of the one or more resources;
retrieving a first of the new passwords for the first resource from the single sign-on database; and
displaying the first password in clear text.

9. The method of claim 8 further comprising determining if a user has provided valid credentials to log in to a system associated with the single sign-on service.

10. A computer implemented method comprising:
detecting that a master password for a single sign-on environment has changed;
retrieving single sign-on login data for a plurality of resources from a single sign-on database, wherein the single sign-on data comprises a username and a current password for each of the plurality of resources;
automatically generating new single sign-on passwords for the plurality of resources;
logging into each of the plurality of resources with respective credentials; and
updating login data on each of the plurality resources with the new single-sign on password generated therefor.

11. The method of claim 10 further comprising, for each of the plurality of resources, overwriting, in the single sign-on database, the current single sign-on password with the new single sign-on password thereof.

12. A computer implemented method comprising:
detecting that single sign-on password for a resource in a single sign-on database has expired;
generating a new single sign-on password for the resource;
logging into the resource with credentials specific to the resource; and
updating login information for the resource with the new single-sign on password.

13. The method of claim 12, wherein said credentials comprise one of
administrator credentials and user credentials.

14. The method of claim 13 further comprising retrieving the credentials for the resource.

15. A computer program product for automatic management of single sign-on passwords, the computer program product comprising
a computer program product for integrating participant profile information into real-time collaborations, the computer program product comprising:
a computer usable medium having computer usable program code embodied therewith, the computer usable program code comprising:
computer usable program code configured to,
determine that one or more current passwords for one or more resources in a single sign-on database should be changed;
generate new passwords for the one or more resources;
automatically log into each of the one or more resources with respective ones of the one or more current passwords; and
update login information on each of the one or more resources with respective ones of the generated new passwords.

16. The computer program product of claim 15, wherein said computer usable program code being configured to determine that the one or more current single sign-on passwords for the one or more resources should be changed comprises at least one of the computer usable code being configured to detect that a master password for a single sign-on environment has changed and detect that a single sign-on password for a resource in the single-sign on database has expired.

17. The computer program product of claim 15, wherein said computer usable program code being configured to generate the new passwords for the one or more resources comprises the computer usable code being configured to generate a first of the new passwords for a first of the one or more resources is based, at least in part, on a master password.

18. The computer program product of claim 15, wherein said computer usable program code being configured to generate the new passwords for the one or more resources comprises the computer usable code being configured to generate a first of the new passwords for a first of the one or more resources independent of a master password.

19. The computer program product of claim 15, wherein said credentials comprise one of administrator credentials or user credentials.

20. The computer program product of claim 19, wherein said computer usable program code is further configured to retrieve first credentials for a first of the one or more resources.

21. The computer program product of claim 15, wherein said computer usable program code is further configured to overwrite the current single sign-on password with the new single sign-on password for each of the one or more resources in the single sign-on database.

22. The computer program product of claim 15, wherein said computer usable program code is further configured to:
detect that a single sign-on service is unavailable for a first of the one or more resources;
retrieve a first of the new passwords for the first resource from the single sign-on database; and
display the first password in clear text.

23. The computer program product of claim 22, wherein said computer usable program code is further configured to determine if a user has provided valid credentials to log in to a system associated with the single sign-on service.

24. An apparatus comprising:
a set of one or more processing units;
a network interface;
a password management unit operable to:
determine that one or more current passwords for one or more resources in a single sign-on database should be changed;
generate new passwords for the one or more resources;
automatically log into each of the one or more resources with respective ones of the one or more current passwords; and
update login information on each of the one or more resources with respective ones of the generated new passwords.

25. The apparatus of claim 24, wherein the password management unit comprises one or more machine-readable media.
